(19) United States
(12) Patent Application Publication
(10) Pub. No.: US 2002/0073220 A1
(43) Pub. Date: Jun. 13, 2002

(54) Method of transmitting multimedia contents from the internet to client systems

(76) Inventor: Sang Baek Lee, Cupertino, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/916,644

(22) Filed: Jul. 26, 2001

Related U.S. Application Data
(60) Provisional application No. 60/220,738, filed on Jul. 26, 2000.

(51) Int. Cl. G06F 15/16

(52) U.S. Cl. 709/231; 709/246

(57) ABSTRACT

A method for transmitting multimedia contents from the Internet to a client system includes, at the client system having a portable multimedia device, selecting desired contents to be received a plurality of sources with different URL addresses. The selected contents are submitted to a server system. The selected contents are transmitted to the client system. The received content is uploaded to the portable multimedia device.

### CROSS-REFERENCE TO RELATED APPLICATION

The present application claims priority to U.S. Provisional Application No. 60/220,738, filed Jul. 26, 2000, which is hereby incorporated by reference.

### BACKGROUND OF THE INVENTION

The present invention generally relates to transferring multimedia content over a wide area network of computers.

Usage of communication networks, such as the Internet, has increased exponentially in recent years. Users of the Internet perform a broad variety of activities ranging from activities for accessing information such as news, weather information, sports related information, stocks information, etc., to performing electronic commerce (e-commerce) related activities such as buying or selling goods/services, and other similar activities.

The Internet is a world wide “super-network” which connects together millions of individual computer networks and computers. The Internet is generally not a single entity. It is an extremely diffuse and complex system over where no single entity has complete authority or control. Although the Internet is widely know for one of its ways of presenting information through the World Wide Web (herein “Web”), there are many other services currently available based upon the general Internet protocols and infrastructure.

The Web is generally easy to use for people inexperienced with computers. Information on the Web often is presented on “pages” of graphics and text that contain “links” to other pages either within the same set of data files (i.e., Web site) or within data files located on other computer networks. Users often access information on the Web using a “browser” program such as one made by Netscape Communications Corporation of Mountain View, Califormia or Explorer from Microsoft Corporation of Redmond, Washington. Browser programs can process information from Web sites and display the information using graphics, text, sound, and animation.

As a result of the ease of use of the Web as well as the breakthrough in computing power and high Internet speed, more and more people are receiving multimedia contents from the Internet. Multimedia contents refer to audio, video, graphical, text, or the like, which the user may access through the PC or other multimedia devices. One significant breakthrough in this area is the emergence of MP3 format. Everyday millions of MP3 users search the Internet to find and download music, songs, and other contents to their PCs. Many of them subsequently uploading the contents to the portable multimedia players (e.g., MP3 players).

Although use of the MP3 portable players is increasing rapidly, searching the Internet for songs or other multimedia contents, downloading them to the PCs, and then uploading them to the portable players can be a tedious process. Under this method, the search, downloading and uploading steps are not integrated, thereby requiring user interventions at each of these steps. Therefore, there is a need for a method which integrates these three separate steps into a single integrated process.

### SUMMARY OF THE INVENTION

In one embodiment, a method for transmitting multimedia contents includes, at a client system, selecting a desired content to be received from a content provider. The selected content is submitted to a server system. The selected content is received at the client system. Thereafter, the received content is uploaded to a portable multimedia device that is coupled to the client system.

In another embodiment, a method for transmitting multimedia contents includes providing a client software accessible via a communication network to be downloaded to a remote computer. The client software is downloaded to a client system. A request for a multimedia content is inputted using the client software in the client system. The request is submitted to a server system via the communication network. At the client system, a content corresponding to the submitted request is received. Thereafter, the received content is uploaded to a portable multimedia device that is coupled to the client system.

In yet another embodiment, a method for transmitting multimedia contents includes inputting a request for a multimedia content using the client software in the client system. The request includes one or more descriptive words relating to the multimedia content, wherein the one or more descriptive words are not communication links. The request is submitted to a server system via a communication network. At the client system, a content corresponding to the submitted request is received. Thereafter, the received content is uploaded to a portable multimedia device that is coupled to the client system.

Features and advantages of the present invention can be more fully appreciated with reference to the detailed description and drawings provided below.

### BRIEF DESCRIPTION OF THE DRAWINGS

FIG. 1 is a simplified diagram of a communication system according to one embodiment of the present invention.

FIG. 2 is a simplified block diagram of the a computer system of the communication system of FIG. 1.

FIG. 3 shows a simplified flow diagram of a method of integrating the steps involved in searching, downloading, and uploading multimedia contents according to one embodiment of the invention.

FIGS. 4-13 illustrate various user interfaces provided by a client software to perform the method of FIG. 3 according to one embodiment of the present invention.

FIG. 14 shows a simplified flow diagram of a method of capturing live data streams according to one embodiment of the present invention.

FIG. 15 shows a sampled flow diagram of a method of providing in-content advertisement according to one embodiment of the present invention.

### DESCRIPTION OF THE SPECIFIC EMBODIMENTS

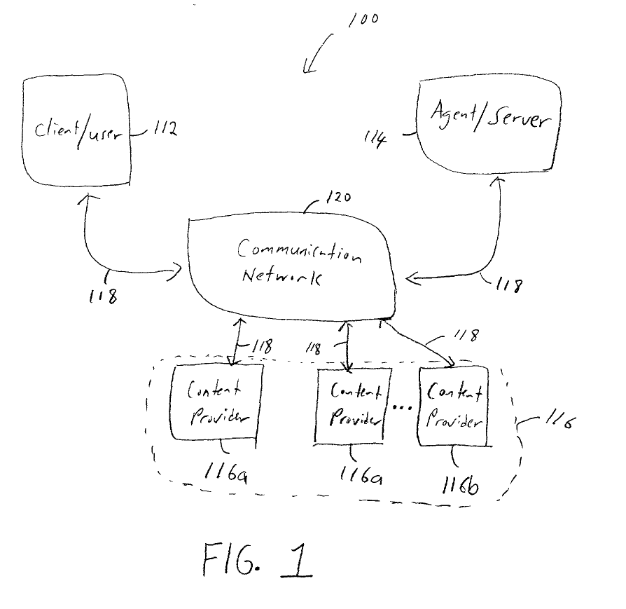

An embodiment of the present invention relates to a method of providing multimedia contents to portable devices. FIG. 1 is a simplified block diagram of a distributed computer network 100 which may incorporate the embodiment of the present invention. Computer network 100 includes a number of computer systems 112, 114, and 116 coupled to a communication network 120 via a plurality of communication links 118. Generally, there are a plurality of client or user systems 112, at least one agent or server system 114, and a plurality of content provider systems 116.

In one embodiment, content provider systems 116 comprise of a plurality of affiliated content provider systems 116a and a plurality of non-affiliated content provider systems 116b. Affiliated content provider systems 116a provide contents or communication links (e.g., Webpage links) to server system 114 to enable user systems 112 to download multimedia contents from the server system or retrieve contents using the links provided by the server system. Non-affiliated content provider systems 116b provide multimedia contents directly to user systems 112.

Communication network 120 provides a mechanism for allowing the various components of computer network 100 to communicate and exchange information with each other. Communication network 120 may itself be comprised of many interconnected computer systems and communication links. Communication links 118 may be hardwire links, optical links, satellite or other wireless communications links, wave propagation links, or any other mechanisms for communication of information. While in one embodiment, communication network 120 is the Internet, in other embodiments, communication network 120 may be any suitable communication network. Distributed computer network 100 depicted in FIG. 1 merely illustrates an embodiment of the present invention and does not limit the scope of the invention as recited in the claims. One of ordinary skill in the art would recognize other variations, modifications, and alternatives.

Computer systems, such as those depicted in FIG. 1, are characterized as “clients” or “servers” depending on the role the computer systems play with respect to requesting information or providing information. Client computers are computers that typically request information from a server computer which provides the information. Server systems are typically responsible for receiving information requests from client systems, performing processing required to satisfy the requests, and for forwarding the results corresponding to the information requests back to the requesting client systems. The processing required to satisfy a client request may be performed by a single server or may alternatively be delegated to other servers connected to communication network 120. A computer system may however act both as a client and a server depending on whether the computer system is requesting or providing information.

User system 112 is typically a client system which allows users to access resources distributed within computer network 100. In an Internet and World Wide Web (WWW) environment, the resources are typically stored in the form of hypertext documents called “web pages” which can be accessed and read by users of the Web. As used herein the web page also includes any other contents displayed on a display device to assist a user in navigating a communication network such as a wide area network. A web page may incorporate any combination of text, graphics, audio and video content, software programs, and other data. Web pages may also contain web page links or hypertext links to other web pages. Web pages are typically stored on servers coupled to communication network 120. Each web page is uniquely identified by an address called a Uniform Resource Locator (URL) that enables users to access the web page. These web pages collectively generally form a website.

Users typically access web pages using a “web browser” program executing on client user system 112. In order to access a web page, the user typically provides URL information to the browser, either directly or indirectly, and the browser responds by retrieving the web page corresponding to the URL information, and displaying it to the user on user system 112. A user typically accesses the investment related information by accessing one or more web pages available in the server system 114 according to the teachings of one embodiment of the present invention.

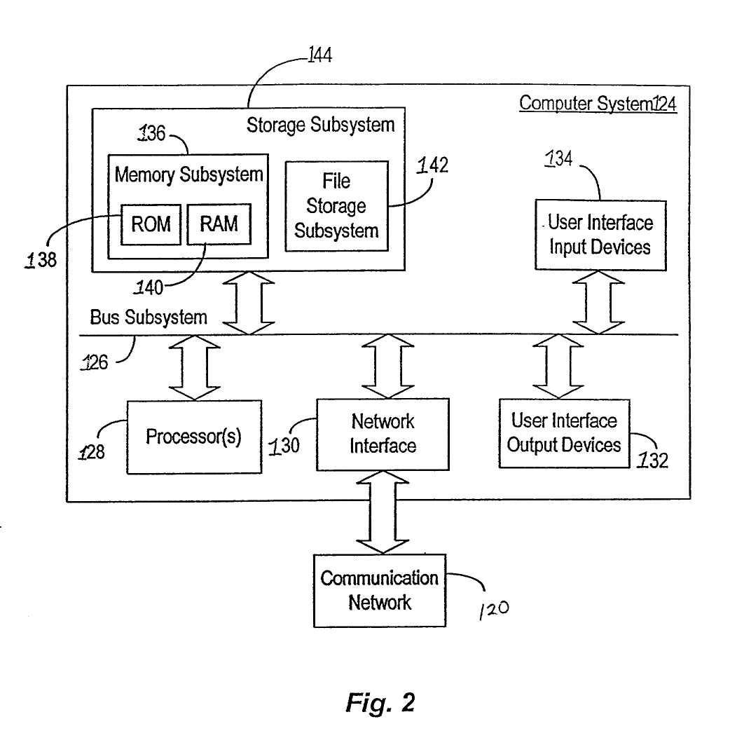

FIG. 2 is a simplified block diagram of an exemplary computer system 124 which may incorporate embodiments of the present invention. Computer system 124 typically includes at least one processor 128 which communicates with a number of peripheral devices via bus subsystem 126. These peripheral devices may include a storage subsystem 144 (typically comprising a memory subsystem 136 and a file storage subsystem 142), user interface input devices 134, user interface output devices 132, and a network interface subsystem 130. The input and output devices allow user interaction with computer system 124. The users may be humans, computers, other machines, applications executed by the computer systems, processes executing on the computer systems, and the like. Network interface subsystem 130 provides an interface to outside networks, including an interface to communication network 116, and is coupled via communication network 120 to corresponding interface devices in other client and server computer systems.

User interface input devices 134 may include a keyboard, pointing devices such as a mouse, trackball, touchpad, a graphics tablet, a scanner, a touchscreen incorporated into the display, audio input devices such as voice recognition systems, microphones, and other types of input devices. In general, use of the term “input device” is intended to include all possible types of devices and ways to input information into computer system 124 or onto computer network 120.

User interface output devices 132 may include a display subsystem, a printer, a fax machine, or non-visual displays such as audio output devices. The display subsystem may be a cathode ray tube (CRT), a flat-panel device such as a liquid crystal display (LCD), or a projection device. The display subsystem may also provide non-visual display such as via audio output devices. In general, use of the term “output device” is intended to include all possible types of devices and ways to output information from computer system 124 to a user or to another machine or computer system.

Storage subsystem 144 stores the basic programming and data constructs that provide the functionality of the various systems embodying the present invention. For example, databases and modules implementing the functionality of the present invention may be stored in storage subsystem 144. These software modules are generally executed by processor 128. In a distributed environment, the software modules and the data may be stored on a plurality of computer systems coupled to communication network 120 and executed by processors of the plurality of computer systems.

Memory subsystem 136 typically includes a number of memories including a main random access memory (RAM) 140 for storage of instructions and data during program execution and a read only memory (ROM) 138 in which fixed instructions are stored. File storage subsystem 142 provides persistent (non-volatile) storage for program and data files, and may include a hard disk drive, a floppy disk drive along with associated removable media, a Compact Digital Read Only Memory (CD-ROM) drive, an optical drive, or removable media cartridges. One or more of the drives may be located at remote locations on other connected computers coupled to communication network 120.

Bus subsystem 126 provides a mechanism for letting the various components and subsystems of computer system 124 communicate with each other as intended. The various subsystems and components of computer system 124 need not be at the same physical location but may be distributed at various locations within distributed network 100. Although bus subsystem 126 is shown schematically as a single bus, alternate embodiments of the bus subsystem may utilize multiple buses.

Computer system 124 itself can be of varying types including a personal computer, a portable computer, a workstation, a computer terminal, a network computer, a television, a mainframe, or any other data processing system. Due to the ever-changing nature of computers and networks, the description of computer system 124 depicted in FIG. 2 is intended only as a specific example for purposes of illustrating the preferred embodiment of the present invention. Many other configurations of computer system 124 are possible having more or less components than the computer system depicted in FIG. 2. Client computer systems, for example, user system 112, and server computer systems, for example, agent system 114, generally have the same configuration as that of computer system 124, with the servers typically having more storage capacity and computing power than the client systems.

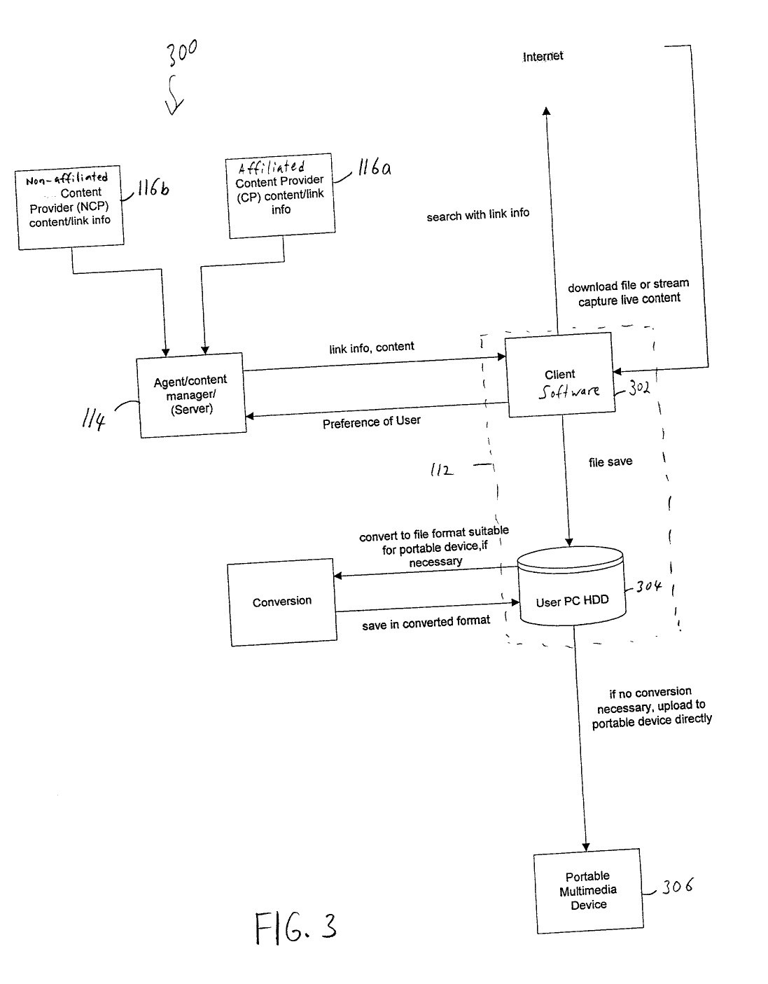

Referring to FIG. 3, an integrated multimedia content retrieval process 300 allows users to search for multimedia contents, download them to PCs, and then upload them to portable multimedia devices with a single input operation from the users. Primarily components involved in implementing process 300 include client system 112, agent system 114, affiliated content provider systems 116a, non-affiliated content provider systems 116b, and a portable multimedia device 306 coupled to the client system. The client system includes a client software 302 and a storage device 304. The client software receives user search requests, communicates with server 114, downloads appropriate contents, and uploads the contents to the portable device, as explained in more detail below.

The multimedia contents are retrieved generally from two sources: affiliated content provider systems (ACP) 116a and non-affiliated content provider systems (NACP) 116b. Affiliated content providers 116a generally have entered agreements with the service provider that operates the server system. As a result, they may be allowed to periodically provide contents to the server database, from which the users can download the contents desired. ACP 116a may attach advertisement or stamp ads to the contents requested by the users. Non-affiliated content providers 116b have not entered agreements with the service provider; consequently, the users are required to download desired contents directly from NACP 116b.

In one embodiment, server system 114 includes an agent, a component that searches the Internet in response to content requests from clients to find the content and/or the link information relating to the request, and a content manager, a person who conducts searches on the Internet to retrieve the contents or links requested by the clients. The server system also includes an NACP DB which holds the contents and links of nonaffiliated content providers, an ACP DB which holds the contents and link information provided by the affiliated content providers, and an ads sponsor DB which holds advertisements to be attached to the contents requested by the clients.

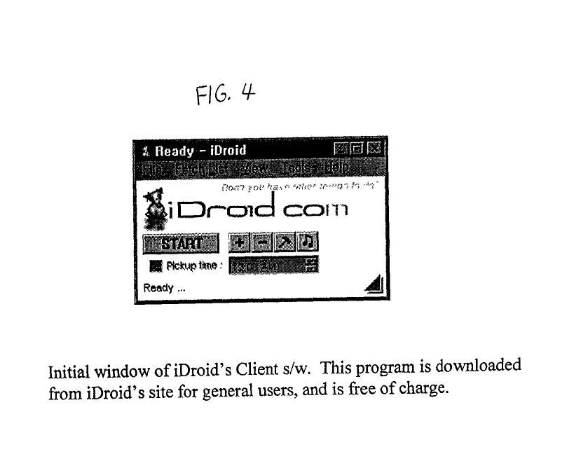

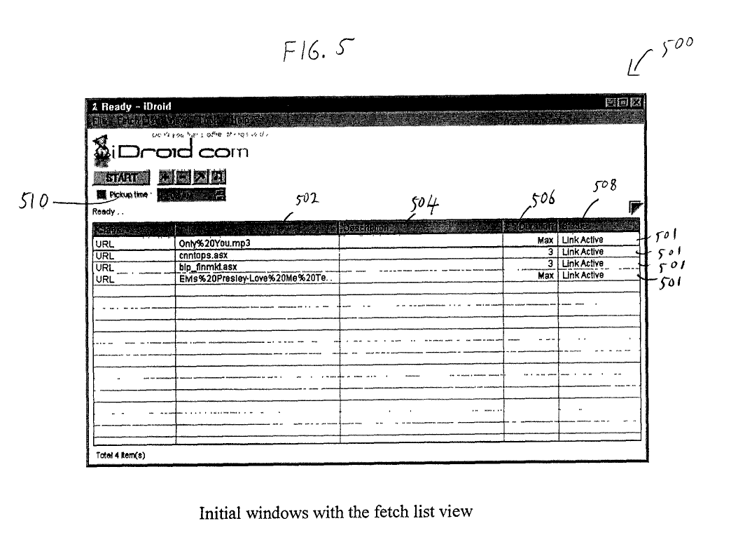

FIGS. 4-13 are exemplary user interfaces provided by client software 302 according to one embodiment of the present invention. FIG. 4 shows an initial user interface 400 of the client software when it is run. A user inputs one or more content or fetch requests to an interface 500 having a plurality of fetch list sections 501 (FIG. 5). The fetch requests can be typed into the fetch list section or drag and dropped therein. The drag and drop procedure involves opening interface 500 and a desired Webpage, highlighting a link within the Webpage, and dragging and dropping the link into one of the fetch list section. Other procedures may be used to input the fetch requests into the fetch list sections. For example, the user may submit as a request a general subject matter, e.g., business news, Stanford University basketball game updates, etc., without providing appropriate communication links.

Interface 500 includes a title section 502, a description section 504, a duration section 506, and a status section 508. The title section generally identifies the contents. The description section generally lists the description of the contents as inputted by the user. The duration section lists an estimated amount of content desired by the user. For example, if the user inputs 3 in the duration section, the user is requesting to download amount of multimedia content that is sufficient to provide 3 minutes of playback time on the portable device. The status section describes the status of particular content request. In one embodiment, interface 500 also includes a pick-up time section 510 where the user can specify when process 300 is to be completed.

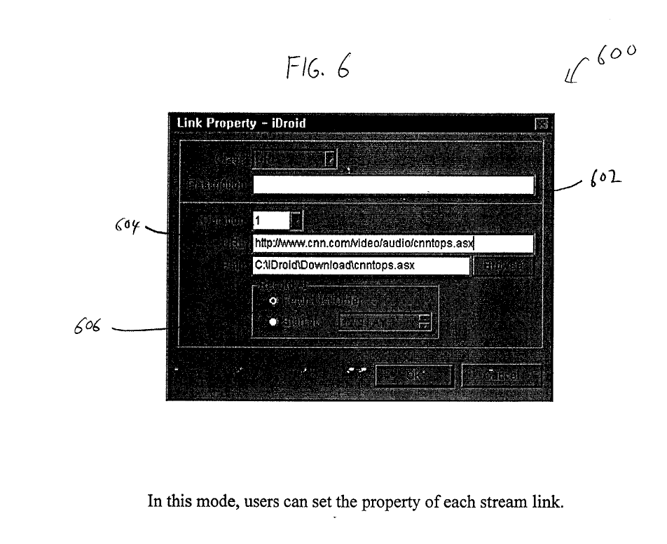

FIG. 6 shows an interface 600 which allows the user to customize the fetch request. The interface includes a description section 602 to input description of the content requested, a duration section 604 to specify amount of content desired, and a record-at section 606 to specify when and what order to retrieve the requested contents. In one embodiment, the record-at section includes fetch list order and start at features. If the fetch list order is selected, the fetch list orders are downloaded from the content providers or server system in the order provided in the interface 500. Alternatively, the user may specify when to commence download by selecting the start at feature.

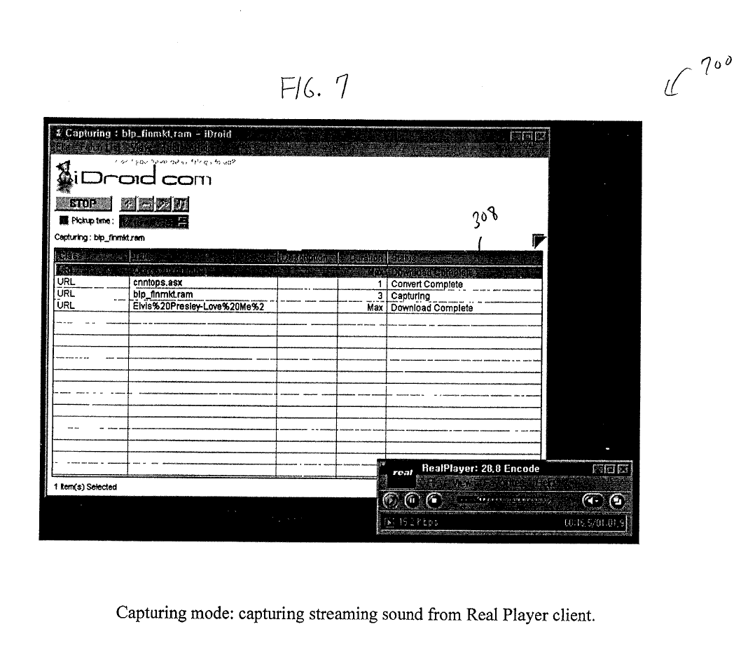

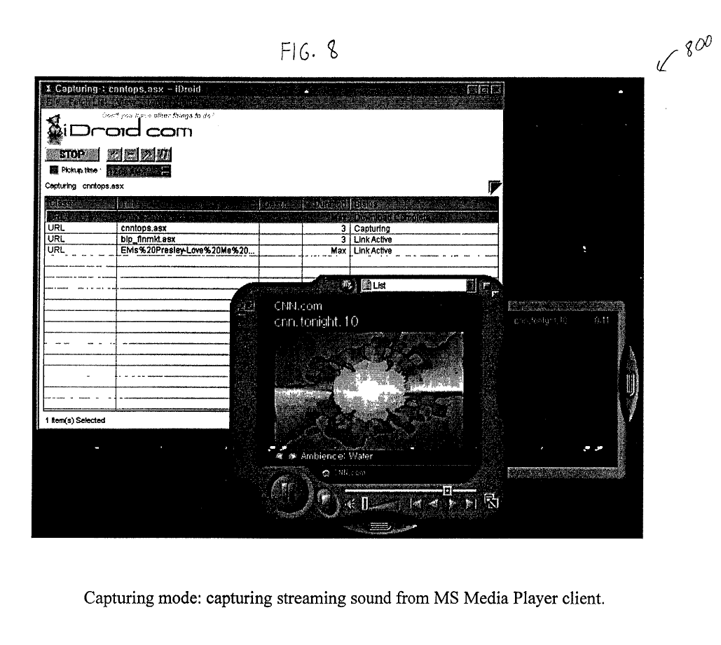

Once the fetch request have been inputted in interface 600, the user transmits the requests to server system 114 to process the request. If the requested content is that of ACP 116a, client 112 may automatically download the content or receive a link where the content can be obtained from the server system. However, if the requested content is that of NACP 116b, server system 114 retrieves the requested content from the NACP 116b and transmit the content to the client. This may be done automatically by using a software application or may be manually retrieved by a content manager with an aid of a search engine. The manual retrieval may be used generally for situations where the client provides a fetch request that merely states a general subject matter without providing a communication address, e.g., URL. Interfaces 700 and 800 show capturing or downloading of streaming audio data (FIGS. 7 and 8). Status section 308 reflects this by indicating “capturing” for the relevant fetch requests.

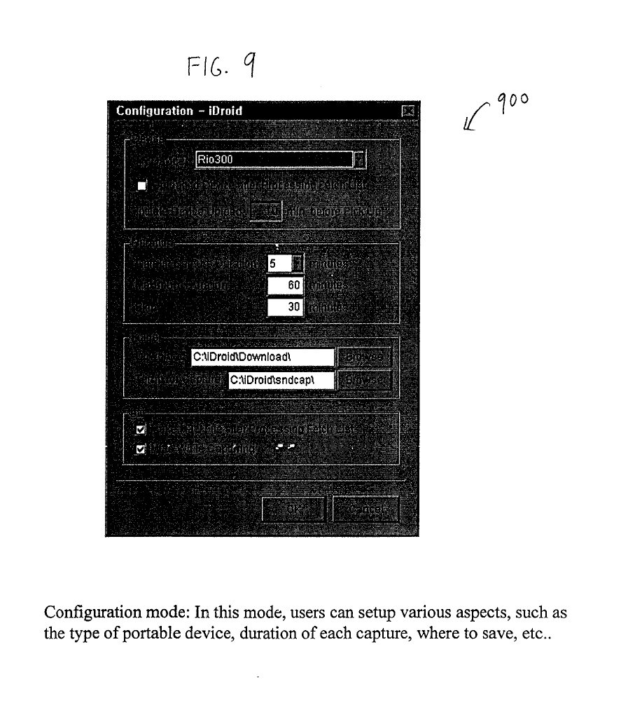

Upon receiving the requested content, it is saved to storage device 304. If the content is in a format that is not suitable for portable device 306 coupled to client 112, the content is converted to a suitable format before it is uploaded to the portable device. Suitable format for the portable device 306 may be determined in a number of different ways. In one embodiment, the user specifies the type of the portable device coupled to the client using an interface 900 of the client software 302 (FIG. 9). Alternatively, client software 302 or another software running within the client may automatically determine the portable device type. Under the above two methods, client software checks the format of the content downloaded to determine its compatibility with portable device 306. A format conversion is initiated if the format of the content is deemed incompatible with the portable device. Subsequently, the converted content is uploaded to the portable device. All of the above steps have been performed automatically by the client system once the user had input the content request to the server.

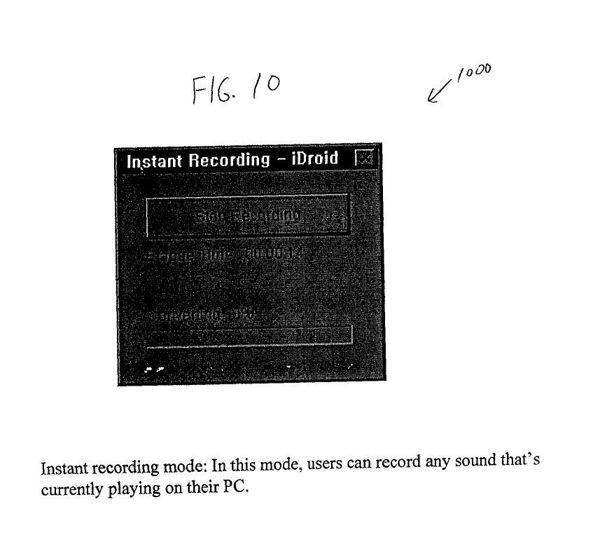

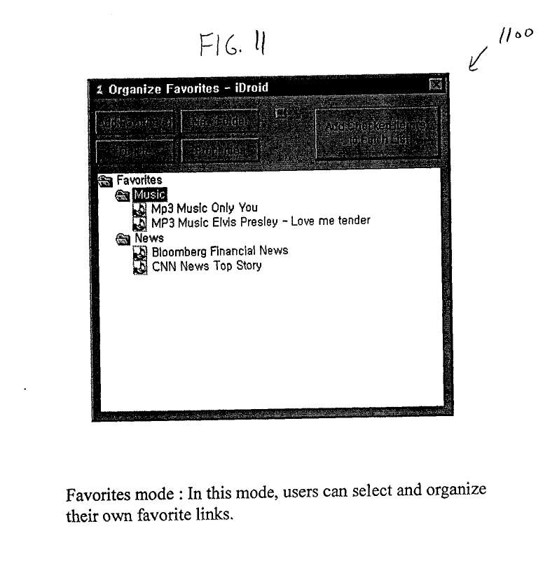

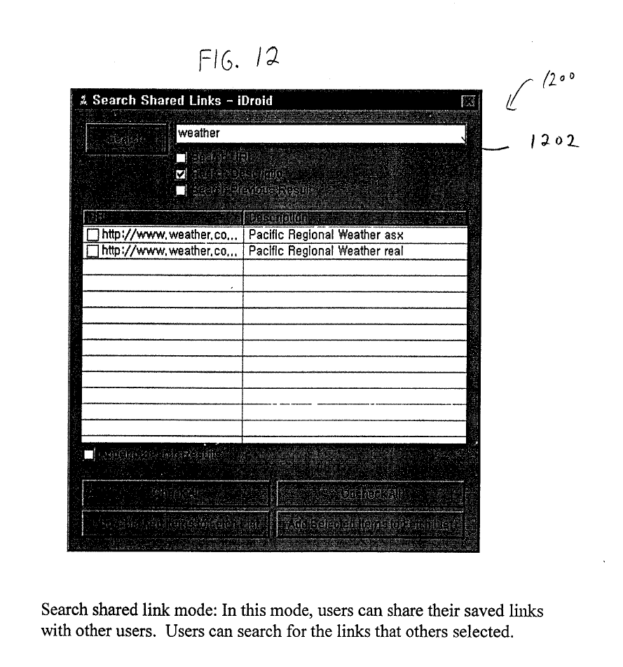

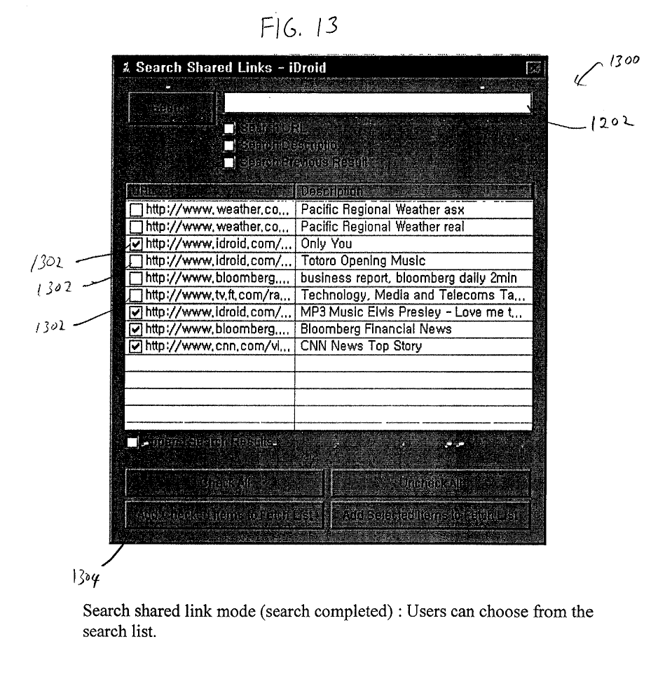

In one embodiment, the client software provides other features. The client software enables the user to save or capture audio data being played by the client system. An interface 1000 shows an audio capturing process according to one embodiment of the present invention (FIG. 10). The streaming audio data which may not otherwise be saved onto storage device 304 may be saved using the client software. For example, streaming audio data may not be easily saved to a PC if the save as selection is disabled by the content provider. The captured audio information may be subsequently uploaded to the portable device or copied onto a CD ROM. FIG. 11 shows an interface 1100 which enables the user to organize his or her favorite links in convenient locations. If the user wishes to obtain contents from any of these links, he or she simply needs to select the links from these locations and perform a drag and drop operation onto the fetch list section. FIGS. 12 and 13 show interfaces 1200 and 1300 that allow the users to share their favorite links with other users. The interfaces include a search section 1202, where the users can specify a particular type of links to be searched. For example, interface 1200 displays the weather links according to the user request for weather links. Interface 1300 includes a check section 1302 to enable user to select particular links and an add-checked-items-to-fetch list section. A user may check the links of interest and click section 1304 to have the checked links inserted into the fetch list section, as shown in interface 500.

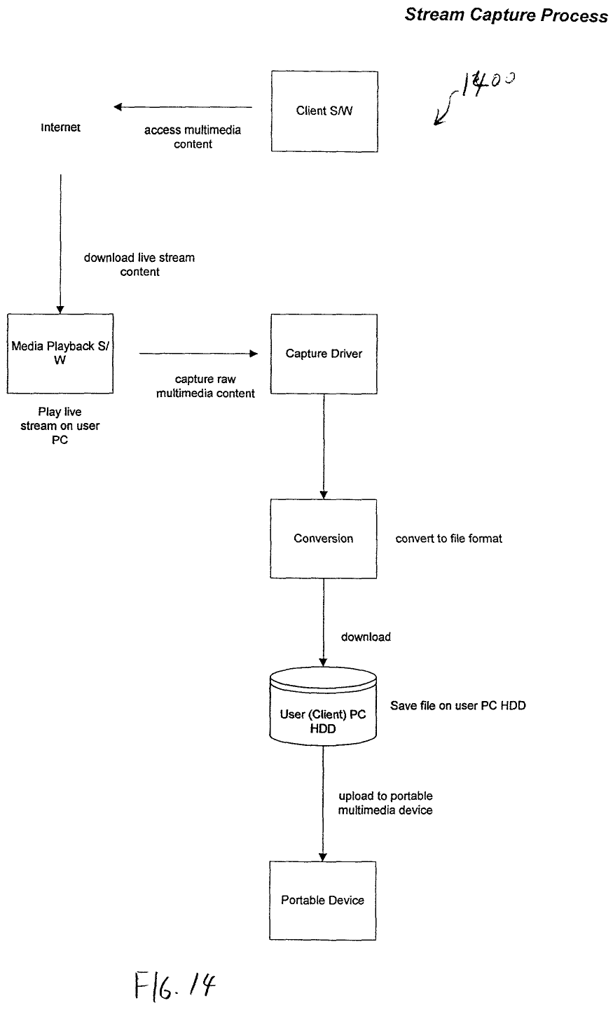

FIG. 14 shows a process 1400 for capturing live streams according to one embodiment of the present invention. Significant amount of the multimedia contents provided nowadays are in the form of live streams that generally cannot be saved by the users. Therefore, it is difficult for users to access such contents at a later time through portable devices. Process 1400 provides a method of capturing live audio and video streams into a file format that can be saved on the user's PC, so that the user may enjoy those contents at later time, e.g., by replaying them on the PC or portable device.

Process 1400 involves transmitting content requests from a user or client 112. Upon finding the desired content, the client downloads the file. However, if the content is in the form of streaming data that cannot be saved as a file, the content is downloaded for playback using a media playback software, such as, Windows Media Player or Real Player. As the downloaded streaming content being played on the user PC, the client software captures the raw multimedia streaming content, converts it into a file format, and saves it on the user's PC. Thereafter, the client uploads the captured file to the portable multimedia device.

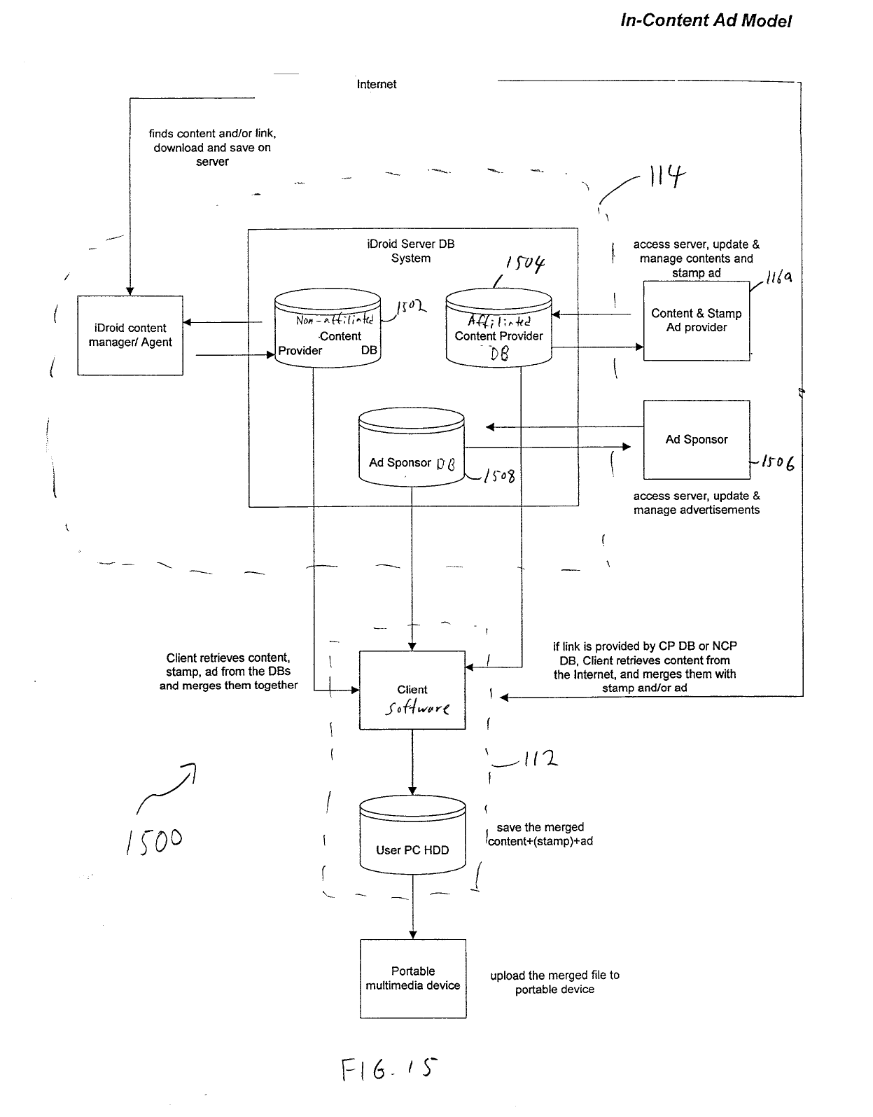

FIG. 15 shows a process 1500 for providing in-content advertisement according to one embodiment of the present invention. Ad sponsors, e.g., ACPs, can attach their streaming advertisements to the contents which are downloaded by the Client. In one embodiment, a single advertisement runs for about 10-15 seconds, generally placed at the beginning or end of the content. The sponsors may update the contents of the advertisements periodically, e.g., once a day. This method enables sponsors to provide targeted advertisements to the users since a company may customize its advertisement according to the contents to which the advertisements are attached.

Process 1500 involves transmitting a content request from client 112. Server 114 retrieves the requested content from appropriate content provider 116 and sends the content to the client. If the desired content does not exists in the database of the server, e.g., content from NACP 116b, server 114 searches the Internet and retrieves the content or link information to be saved on an NACP DB 1502 as well as sending the content or link information to the client. For the subsequent requests for that content, the server may access the NACP DB to handle such requests. On the other hand, if the desired content is that provided by ACP 116a, the client automatically retrieve the content or the link information from an ACP DB 1504. In one embodiment, each ACP is allowed to attach a stamp ad or advertisement at the end of each content it has provided. The stamp ad is a short description of the content provider. In addition to ACPs 116a, ad sponsors 1506 may attach advertisements to the contents provided to the client. Ad sponsors 1508 may be provided with an ad sponsor database 1508 in the server system. The database 1508 is managed and updated by the ad sponsors. Advertisements of the ad sponsor are attached to contents specified by the ad sponsors. They specify the type of content to which the advertisements are to be attached, the locations with respect to the content (beginning, end, or within the content) to which they are to be attached, the number of times that the advertisement are to be attached, and the like. When the client receives the content, the stamp ad (if any), and the advertisements, it merges all of them together and save it as one file in the user's storage device 304. If the contents need to be converted to a different format, it is done before merging so that the merged contents all have the same format. The client then uploads the merged contents to the portable device.

While specific embodiments are disclosed above, many variations are possible which remain within the concept and scope of the invention. The scope of the invention should, therefore, be determined not with reference to the above description, but instead should be determined with reference to the appended claims along with their full scope of equivalents.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

[image]

What is claimed is:

1. A method for transmitting multimedia contents, comprising:
at a client system selecting a desired content to be received from a content provider;
submitting the selected content to a server system;
receiving the selected content at the client system; and
thereafter, uploading the received content to a portable multimedia device that is coupled to the client system.

2. The method of claim 1, further comprising:
attaching an information to the selected content to promote a business entity.

3. The method of claim 1, wherein the selected content is in a first format, the method further comprising:
converting the content in the first format to a second format.

4. The method of claim 3, wherein the portable device recognizes the second format but not the first format.

5. The method of claim 3, further comprising:
identifying the portable device coupled to the client system to provide the client system with information as to which format is compatible with the portable device.

6. The method of claim 3, wherein the client system determines which formats are compatible with the portable device without requiring a user to identify the portable device.

7. A method for transmitting multimedia contents, comprising:
providing a client software accessible via a communication network to be downloaded to a remote computer;
downloading the client software to a client system;
inputting a request for a multimedia content using the client software in the client system;
submitting the request to a server system via the communication network;
receiving at the client system a content corresponding to the submitted request; and
thereafter, uploading the received content to a portable multimedia device that is coupled to the client system.

8. The method of claim 7, further comprising:
attaching an advertisement to the content corresponding to the submitted request.

9. The method of claim 7, wherein the content corresponding to the submitted request is streaming data.

10. The method of claim 9, further comprising:
playing the streaming data on the client system; and
capturing the streaming data as a storable file.

11. A method for transmitting multimedia contents, comprising:
inputting a request for a multimedia content using the client software in the client system, the request including one or more descriptive words relating to the multimedia content, wherein the one or more descriptive words are not communication links;
submitting the request to a server system via a communication network;
receiving at the client system a content corresponding to the submitted request; and
thereafter, uploading the received content to a portable multimedia device that is coupled to the client system.

12. The method of claim 11, wherein the content is audio or video data.

13. The method of claim 11, further comprising:
searching for a content provider that has the content corresponding to the submitted request; and
retrieving the content corresponding to the submitted request to the server system in order to download the content to the client system.
